(19) United States
(12) Patent Application Publication
(10) Pub. No.: US 2026/0072211 A1
(43) Pub. Date: Mar. 12, 2026

(54) OPTICAL WAVEGUIDE COMPONENT AND METHOD OF MANUFACTURING OPTICAL WAVEGUIDE COMPONENT

(71) Applicant: SUMITOMO ELECTRIC INDUSTRIES, LTD., Osaka (JP)

(72) Inventors: Takeru NAITO, Osaka (JP); Tetsuya NAKANISHI, Osaka (JP); Hajime ARAO, Osaka (JP)

(73) Assignee: SUMITOMO ELECTRIC INDUSTRIES, LTD., Osaka (JP)

(21) Appl. No.: 19/318,464

(22) Filed: Sep. 4, 2025

(30) Foreign Application Priority Data
Sep. 11, 2024 (JP) 2024-157622

(51) Int. Cl. G02B 6/122; G02B 6/13

(52) U.S. Cl. CPC G02B 6/122; G02B 6/13

(57) ABSTRACT

An optical waveguide component includes a base material portion, and a modified region. The modified region extends in a first direction inside the base material portion and has a refractive index different from a refractive index of the base material portion. The modified region includes a high refractive index region and a low refractive index region. The high refractive index region has a refractive index higher than the refractive index of the base material portion. The low refractive index region has a refractive index lower than the refractive index of the base material portion. The low refractive index region is arranged at each of four sides of the high refractive index region in the cross-section intersecting the first direction.

### CROSS REFERENCE TO RELATED APPLICATIONS

This application claims priority based on Japanese Patent Application No. 2024-157622 filed on Sep. 11, 2024, and the entire contents of the Japanese patent application are incorporated herein by reference.

### TECHNICAL FIELD

The present disclosure relates to optical waveguide components and methods of manufacturing optical waveguide components.

### BACKGROUND

An optical waveguide component having a modified region inside a base material portion is known (see Non-patent literature 1: Zhengming Liu et al. “Fabrication of an Optical Waveguide-Mode-Field Compressor in Glass Using a Femtosecond Laser” Materials 2018, 11, 1926 and Non-patent literature 2: G. Corrielli et al. “Femtosecond Laser micromachining for integrated quantum photonics” Nanophotonics, 10 (15), 3789-3812.). The modified region extends in the first direction inside the base material portion and has a refractive index different from the refractive index of the base material portion. The modified region includes a high refractive index region having a refractive index higher than the refractive index of the base material portion.

### SUMMARY

An optical waveguide component according to an embodiment of the present disclosure includes a base material portion and a modified region. The modified region extends in a first direction inside the base material portion and has a refractive index different from a refractive index of the base material portion. The modified region includes a high refractive index region and a low refractive index region. The high refractive index region has a refractive index higher than the refractive index of the base material portion. The low refractive index region has a refractive index lower than the refractive index of the base material portion. The low refractive index region is arranged at each of four sides of the high refractive index region in a cross-section intersecting the first direction.

### BRIEF DESCRIPTION OF THE DRAWINGS

FIG. 1 is a perspective view schematically showing an optical waveguide component in an embodiment.

FIG. 2 is a cross-sectional view of an optical waveguide component showing an example of the shape of a modified region.

FIG. 3 is a diagram showing a refractive index profile of a modified region.

FIG. 4 is a partial enlarged view of the modified region.

FIG. 5 shows a profile of a beam that is guided in an optical waveguide component.

### DETAILED DESCRIPTION

In Non-patent literature 1 and Non-patent literature 2, a low refractive index region having a refractive index lower than the refractive index of the base material portion is arranged near the high refractive index region described above. This improves the refractive index of the high refractive index region. The high refractive index region corresponds to an optical waveguide. In this case, however, there is a possibility that the shape of the high refractive index region may become distorted. If the high refractive index region deforms from the Gaussian shape, there is a possibility that the desired light transmission could be unattainable.

The object of the present disclosure is to provide an optical waveguide component that maintains a desired shape of the high refractive index region, and a method of manufacturing the optical waveguide component.

### Description of Embodiments of Present Disclosure

First, contents of embodiments of the present disclosure will be individually listed and described.
(1) An optical waveguide component according to an embodiment of the present disclosure includes a base material portion and a modified region. The modified region extends in a first direction inside the base material portion and has a refractive index different from a refractive index of the base material portion. The modified region includes a high refractive index region and a low refractive index region. The high refractive index region has a refractive index higher than the refractive index of the base material portion. The low refractive index region has a refractive index lower than the refractive index of the base material portion. The low refractive index region is arranged at each of four sides of the high refractive index region in a cross-section intersecting the first direction.
In this optical waveguide component, the low refractive index region is arranged at each of four sides of the high refractive index region in a cross-section intersecting the first direction. In this case, the low refractive index region improves the refractive index of the high refractive index region, and the high refractive index region is formed in a desired shape.
(2) In the optical waveguide component according to the above (1), the high refractive index region may include a pair of end portions. The base material portion may include a first end surface, a second end surface, a first main surface, and a second main surface. A first end portion that is one of the pair of end portions may be exposed at the first end surface. The second end surface at which a second end portion that is another one of the pair of end portions is exposed may be located opposite to the first end surface in the first direction. The first main surface may connect the first end surface and the second end surface to each other. The second main surface may connect the first end surface and the second end surface to each other, and may be located opposite to the first main surface in a second direction intersecting the first direction. The low refractive index regions may include a first low refractive index region and a second low refractive index region separated from each other in a third direction intersecting each of the first direction and the second direction. The high refractive index region may be arranged between the first low refractive index region and the second low refractive index region. A portion of the base material portion may be arranged between the first low refractive index region and the high refractive index region. In this case, leakage of light propagating through the high refractive index region to the first low refractive index region is reduced.
(3) In the optical waveguide component according to the above (2), a shortest distance between the high refractive index region and the first low refractive index region may be larger than a half a width of the first low refractive index region in the third direction. In this case, leakage of light propagating through the high refractive index region to the first low refractive index region is further reduced.
(4) In the optical waveguide component according to the above (2), a shortest distance between the high refractive index region and the first low refractive index region may be smaller than twice a width of the first low refractive index region in the second direction. In this case, leakage of light propagating through the high refractive index region to the first low refractive index region is further reduced.
(5) In the optical waveguide component according to any one of the above (2) to (4), a width of the first low refractive index region may be larger than a width of the high refractive index region in the second direction. In this case, leakage of light propagating through the high refractive index region to the first low refractive index region is further reduced.
(6) A method of manufacturing an optical waveguide according to an embodiment of the present disclosure includes a base material portion, a first end surface, a second end surface, a first main surface, and a second main surface. The second end surface is located opposite to the first end surface in the first direction. The first main surface connects the first end surface and the second end surface to each other. The second main surface connects the first end surface and the second end surface to each other and is located opposite to the first main surface in a second direction intersecting the first direction. The modified region is formed which extends in a first direction inside a base material portion and has a refractive index different from a refractive index of the base material portion by scanning the base material portion with a laser beam along the first direction from a side of the first main surface. The modified region includes a high refractive index region having a refractive index higher than the refractive index of the base material portion, and a low refractive index region having a refractive index lower than the refractive index of the base material portion. In the forming of the modified region, the low refractive index region is formed at each of four sides of the high refractive index region in a cross-section intersecting the first direction. Thus, this allows the low refractive index region to maintain the desired shape of the high refractive index region while improving the refractive index of the high refractive index region.

### Details of Embodiments of Present Disclosure

Specific examples of embodiments of the present disclosure are described below with reference to the drawings. The present disclosure is not limited to these examples, but is defined by the scope of the claims, and is intended to include all modifications within the meaning and scope equivalent to the scope of the claims. In the description of the drawings, the same elements are denoted by the same reference numerals, and redundant description will be omitted.

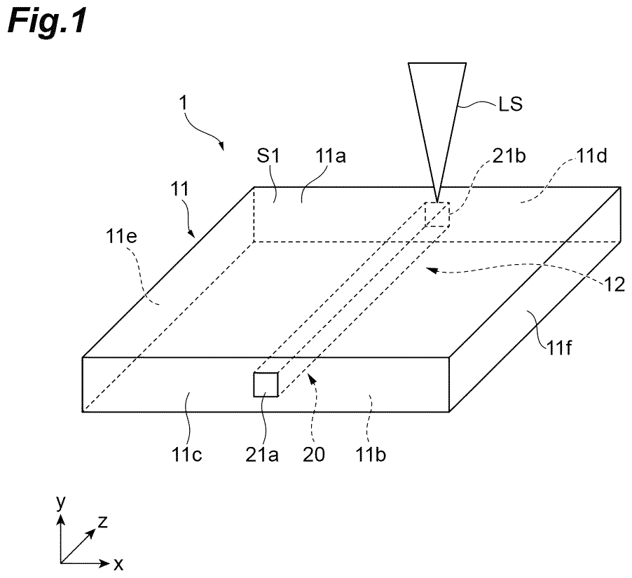

FIG. 1 is a perspective view schematically showing an optical waveguide component according to an embodiment. In these figures, an XYZ orthogonal coordinate system is shown for ease of understanding.

An optical waveguide component 1 guides light in a desired direction. The optical waveguide component 1 is used, for example, to convert the mode field diameter. The optical waveguide component 1 suitably converts the mode field diameter and refractive index difference between the optical fiber that connects to the optical waveguide component 1 and a silicon photonics chip, thereby reducing optical loss. The optical waveguide component 1 guides, for example, light from an optical fiber to an optical waveguide of the silicon photonics chip. The optical waveguide component 1 includes a base material portion 11 and a modified region 12.

The base material portion 11 has a surface S1 where the modified region 12 is exposed. As shown in FIG. 1, the surface S1 includes a pair of main surfaces 11a and 11b, a pair of end surfaces 11c and 11d, and a pair of side surfaces 11e and 11f. The pair of main surfaces 11a and 11b, the pair of end surfaces 11c and 11d, and the pair of side surfaces 11e and 11f are, for example, flat surfaces and rectangular. The base material portion 11 has, for example, a substantially rectangular parallelepiped shape. The base material portion 11 has a plate shape, and the Z-axis direction corresponds to the thickness direction. The base material portion 11 is made of, for example, glass. The material of the base material portion 11 is, for example, quartz glass, alkali-free glass, or borosilicate glass.

The pair of main surfaces 11a and 11b are along the X-axis direction and the Z-axis direction, and face each other in the Y-axis direction. One of the pair of main surfaces 11a and 11b is located opposite to the other in the Y-axis direction. The pair of main surfaces 11a and 11b are arranged in the Y-axis direction may be parallel to each other or inclined to each other. The main surface 11a connects the side surface 11e and a side surface 11f. A main surface 11b connects the side surface 11e and the side surface 11f and is located opposite to the main surface 11a in the Y-axis direction. For clarity, one of the pair of main surfaces 11a and 11b and the other of the pair may also be referred to as a first main surface and a second main surface, respectively.

The pair of end surfaces 11c and 11d are along the X-axis direction and the Y-axis direction, and face each other in the Z-axis direction. One of the pair end surfaces 11c and 11d are located opposite to the other in the Z-axis direction. The pair of end surfaces 11c and 11d are arranged in the Z-axis direction, and may be parallel to each other or inclined with respect to each other. The end surface 11c connects the main surface 11a and the main surface 11b. An end surface 11d connects the main surface 11a and the main surface 11b and is located opposite to the end surface 11c in the Z-axis direction. For clarity, one of the pair of end surfaces 11c and 11d and the other of the pair may also be referred to as a first end surface and a second end surface, respectively.

The pair of side surfaces 11e and 11f are along the Y-axis direction and the Z-axis direction, and face each other in the X-axis direction. One of the pair of side surfaces 11e and 11f is located opposite to the other in the X-axis direction. The pair of side surfaces 11e and 11f are arranged in the X-axis direction, and may be parallel to each other or inclined with respect to each other. The side surface 11e connects the end surface 11c and the end surface 11d. The side surface 11f connects the end surface 11c and the end surface 11d, and is located opposite to the end surface 11e in the X-axis direction. For clarity, one of the pair of side surfaces 11e and 11f and the other of the pair may also be referred to as a first side surface and a second side surface, respectively.

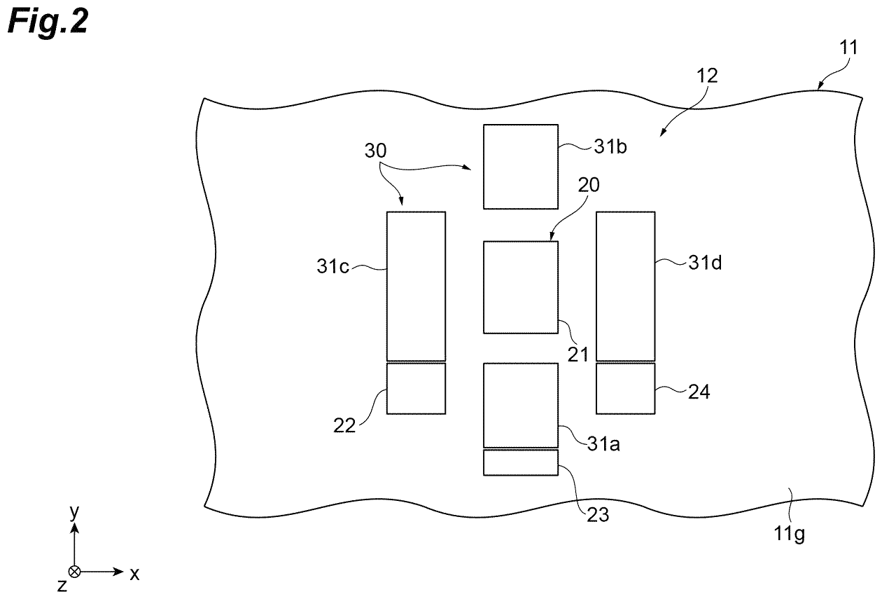

The modified region 12 extends in the Z-axis direction inside the base material portion 11 and has a refractive index different from the refractive index of the base material portion 11. As shown in FIG. 2, the modified region 12 includes a high refractive index region 20 and a low refractive index region 30.

The high refractive index region 20 has a refractive index higher than the refractive index of the base material portion 11. As shown in FIG. 2, the high refractive index region 20 includes high refractive index regions 21, 22, 23 and 24. The high refractive index region 21 is a core formed inside the base material portion 11. The high refractive index region 21 corresponds to an optical waveguide through which light propagates.

The high refractive index region 21 extends in the Z-axis direction and propagates light in that direction. The high refractive index region 21 has a pair of end portions 21a and 21b. The pair of end portions 21a and 21b includes the first end portion 21a and a second end portion 21b opposite to the first end portion 21a. The first end portion 21a is exposed to the end surface 11c of the base material portion 11. The second end portion 21b is exposed to the end surface 11d of the base material portion 11. For example, the first end portion 21a is coupled to an optical fiber 2, and the second end portion 21b is coupled to the optical waveguide of the silicon photonics chip. The high refractive index region 21 may guide light from the first end portion 21a to the second end portion 21b, or may guide light from the second end portion 21b to the first end portion 21a.

The high refractive index regions 22, 23 and 24 are provided along the low refractive index region 30. The high refractive index regions 22, 23 and 24 are located closer to the main surface 11b than the low refractive index region 30 in the Y-axis direction, receptively.

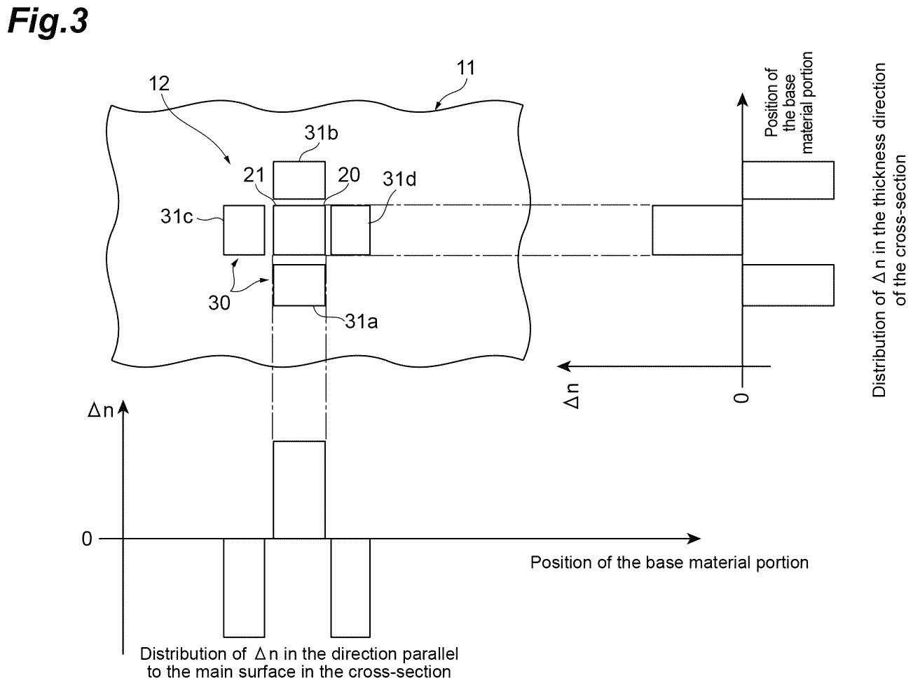

The low refractive index region 30 has a refractive index lower than the refractive index of the base material portion 11. The low refractive index region 30 is arranged at each of four sides of the high refractive index region 20 in a cross-section 11g intersecting the Z-axis direction. As shown in FIG. 3, the high refractive index region 21 is surrounded by low refractive index regions 31a, 31b, 31c, and 31d. The low refractive index region 30 includes the low refractive index regions 31a, 31b, 31c, and 31d.

The low refractive index region 31a and the low refractive index region 31b are arranged in the Y-axis direction. The low refractive index region 31a and the low refractive index region 31b are separated from each other in the Y-axis direction. The low refractive index region 31a is located closer to the main surface 11b than the low refractive index region 31b. For example, the high refractive index region 21 is arranged between the low refractive index region 31a and the low refractive index region 31b. A high refractive index region 23 is located closer to the main surface 11b than the low refractive index region 31a. In the Y-axis direction, the low refractive index region 31a, the low refractive index region 31b, the high refractive index region 21, and the high refractive index region 23 are arranged so as to overlap each other. In the Y-axis direction, the high refractive index region 23, the low refractive index region 31a, the high refractive index region 21, and the low refractive index region 31b are arranged in this order closer to the main surface 11b.

The high refractive index region 22 is located closer to the main surface 11b than a low refractive index region 31c. In the Y-axis direction, the low refractive index region 31c and the high refractive index region 22 are arranged so as to overlap each other. In the Y-axis direction, the high refractive index region 22 and the low refractive index region 31c are arranged in this order closer to the main surface 11b.

A high refractive index region 24 is located closer to the main surface 11b than a low refractive index region 31d. In the Y-axis direction, the low refractive index region 31d and the high refractive index region 24 are arranged so as to overlap each other. In the Y-axis direction, the high refractive index region 24 and the low refractive index region 31d are arranged in this order closer to the main surface 11b.

The low refractive index region 31c and the low refractive index region 31d are arranged in the X-axis direction. The low refractive index region 31c and the low refractive index region 31d are separated from each other in the X-axis direction. The low refractive index region 31d is located closer to the side surface 11f than the low refractive index region 31c. For example, the high refractive index region 21 is arranged between the low refractive index region 31c and the low refractive index region 31d. In the X-axis direction, the low refractive index region 31c, the low refractive index region 31d, and the high refractive index region 21 are arranged so as to overlap each other. In the X-axis direction, the low refractive index region 31c, the high refractive index region 21, and the low refractive index region 31d are arranged in this order closer to the side surface 11e.

The low refractive index region 31c and the high refractive index region 21 are separated from each other in the X-axis direction. The portion of the base material portion 11 is arranged between the low refractive index region 31c and the high refractive index region 21. The low refractive index region 31d and the high refractive index region 21 are separated from each other in the X-axis direction. The portion of the base material portion 11 is arranged between the low refractive index region 31d and the high refractive index region 21.

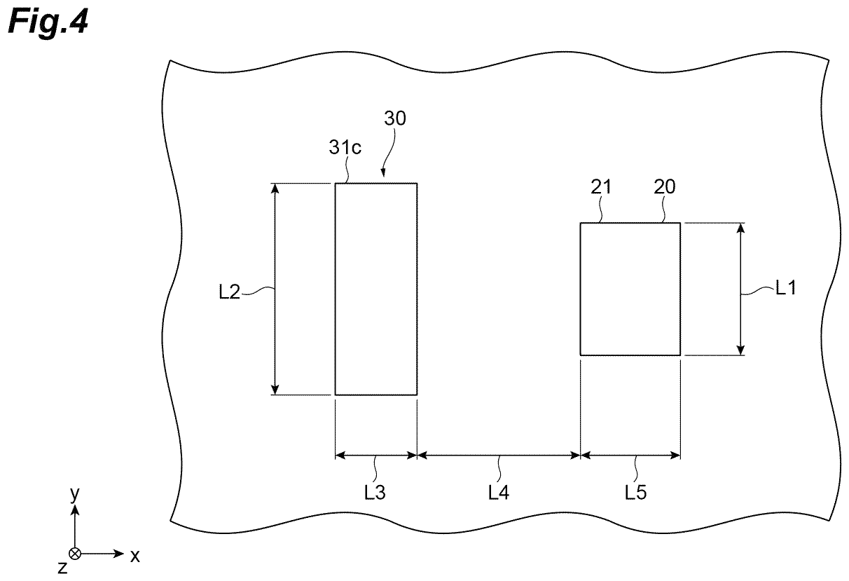

FIG. 4 is a partial enlarged view of the modified region 12 at the end surface 11c. As shown in FIG. 4, in the Y-axis direction, a width L2 of the low refractive index regions 31c and 31d is larger than a width L1 of the high refractive index region 21. A shortest distance L4 between the high refractive index region 21 and the low refractive index region 31c is smaller than twice the width L2 of the low refractive index region 31c in the Y-axis direction. The shortest distance L4 between the high refractive index region 21 and the low refractive index region 31c is larger than a half a width L3 of the low refractive index region 31c in the X-axis direction.

The widths L1, L2, and L3 and the shortest distance L4 are determined based on the coordinates of the edges indicating the contours of the low refractive index regions 31c and 31d and the high refractive index region 21. The coordinates are those observed in the measurement microscope. The measuring microscope is, for example, STM7. For example, the edge of the high refractive index region 21 is detected using the edge detection function of the measurement microscope at a magnification at which one of the low refractive index regions 31c and 31d and the high refractive index region can be visually recognized at the same time in the measurement microscope. The edges of the low refractive index regions 31c and 31d are detected by sweeping in the X-axis direction from the detection of the edge of the high refractive index region 21 and using the edge detection function of the measurement microscope, for example. For example, the shortest distance L4 between the high refractive index region 21 and the low refractive index region 31c is an absolute value of a difference between an X coordinate of an edge of the high refractive index region 21 and an X coordinate of an edge of the low refractive index region 31c. The X coordinate is a coordinate on the X axis.

In the configuration shown in FIG. 2, the low refractive index region 31a and the high refractive index region 21 are separated from each other in the Y-axis direction. For example, the portion of the base material portion 11 is arranged between the low refractive index region 31a and the high refractive index region 21. The low refractive index region 31b and the high refractive index region 21 are separated from each other in the Y-axis direction. The portion of the base material portion 11 is arranged between the low refractive index region 31b and the high refractive index region 21.

The modified region 12 is formed by scanning a laser beam LS along the Z-axis direction from the outside of the main surface 11a with respect to the base material portion 11. For example, the modified region 12 is a laser beam processing region formed by condensing and scanning the laser beam LS having an extremely short time width such as a femtosecond order on the inside of the base material portion 11 and modifying the glass by multiphoton absorption.

For example, in the formation of the modified region 12, the low refractive index region 30 is formed on each of four sides of the high refractive index region 21 in the cross-section 11g by scanning the laser beam LS along the Z-axis direction. By scanning the laser beam LS along the Z-axis direction, the low refractive index region 31a, the high refractive index region 21, and the low refractive index region 31b are formed. Further, the low refractive index region 31c and the low refractive index region 31d are formed by scanning the laser beam LS along the Z-axis direction. For example, by scanning the laser beam LS along the Z-axis direction, the high refractive index region 23 is formed together with the low refractive index region 31a, the high refractive index region 21 is formed together with the low refractive index region 31b, the high refractive index region 22 is formed together with the low refractive index region 31c, and the high refractive index region 24 is formed together with the low refractive index region 31d.

For example, the high refractive index region 23 is formed and the low refractive index region 31a is formed by scanning the laser beam LS along the Z-axis direction, and after the high refractive index region 23 and the low refractive index region 31a are formed, the high refractive index region 21 is formed and the low refractive index region 31b is formed by scanning the laser beam LS along the Z-axis direction. As a modification of the embodiment, the high refractive index region 21 may be formed and the low refractive index region 31b may be formed by scanning the laser beam LS along the Z-axis direction, and the low refractive index region 31a may be formed by scanning the laser beam LS along the Z-axis direction after the high refractive index region 21 and the low refractive index region 31b are formed.

Through the scanning of the laser beam LS, the high refractive index region 21 is formed at a position closer to the main surface 11a than the low refractive index region 31a and overlapping the low refractive index region 31a when viewed along the Y-axis direction. Through the scanning of the laser beam LS, the low refractive index region 31b is formed at a position closer to the main surface 11a than the high refractive index region 21 and overlapping the low refractive index region 31a when viewed along the Y-axis direction. Through the scanning of the laser beam LS, the low refractive index region 31c and the low refractive index region 31d are formed at positions overlapping the high refractive index region 21 when viewed along the X-axis direction and sandwiching the high refractive index region 21 when viewed along the Z-axis direction.

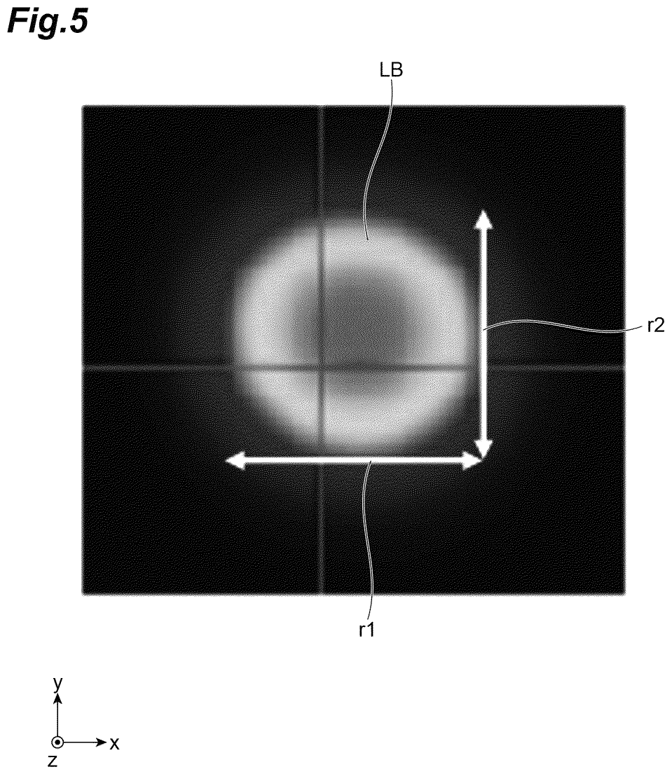

Referring to FIG. 5, the effect of the optical waveguide component 1 will be described. In the optical waveguide component 1, the low refractive index region 30 is arranged at each of four sides of the high refractive index region 21 in the cross-section 11g. In this case, the low refractive index region 30 improves the refractive index of the high refractive index region 21, and the high refractive index region 21 is formed in a desired shape. FIG. 5 shows a profile of a beam LB guided in the optical waveguide component 1. In FIG. 5, the beam profile is imaged using the near field pattern (NFP) method. A radius w0 is calculated by Gaussian fitting the distributions projected on the X-axis and the Y-axis, and the value of the twice of the w0 becomes the MFD (Mode Field Diameter) in each axis. The MFD in the x-axis direction is r1, and the MFD in the y-axis direction is r2. The r1 and the r2 are substantially equal to each other, and the MFD is formed in a substantially perfect circle.

In the optical waveguide component 1, the high refractive index region 21 has a pair of end portions 21a and 21b. The base material portion 11 includes the end surface 11c, the end surface 11d, the main surface 11a, and the main surface 11b. In the end surface 11c, one of the pair of end portions 21a and 21b is exposed. The end surface 11d has the other of the pair of end portions 21a and 21b exposed, and is located opposite to the end surface 11c in the Z-axis direction. For clarity, one of the pair of end portions 21a and 21b and the other of the pair may also be referred to as a first end portion and a second end portion, respectively. The main surface 11a connects the side surface 11e and the side surface 11f. The main surface 11b connects the side surface 11e and the side surface 11f and is located opposite to the main surface 11a in the Y-axis direction. The low refractive index region 30 includes the low refractive index region 31c and the low refractive index region 31d that are separated from each other in the X-axis direction. The high refractive index region 21 is arranged between the low refractive index region 31c and the low refractive index region 31d. The portion of the base material portion 11 may be arranged between the low refractive index region 31c and the high refractive index region 21. In this case, leakage of light propagating through the high refractive index region 21 to the low refractive index region 31c is reduced.

In the optical waveguide component 1, the shortest distance L4 between the high refractive index region 21 and the low refractive index region 31c is than a half the width L3 of the low refractive index region 31c in the X-axis direction. In this case, leakage of light propagating through the high refractive index region 21 to the low refractive index region 31c is further reduced.

In the optical waveguide component 1, the shortest distance L4 between the high refractive index region 21 and the low refractive index region 31c is smaller than twice the width L2 of the low refractive index region 31c in the Y-axis direction. In this case, leakage of light propagating through the high refractive index region 21 to the low refractive index region 31c is further reduced.

In the optical waveguide component 1, in the Y-axis direction, the width L2 of the low refractive index region 31c may be longer than the width L1 of the high refractive index region 21. In this case, leakage of light propagating through the high refractive index region 21 to the low refractive index region 31c is further reduced.

Although the embodiments of the present disclosure have been described in detail, the present disclosure is not limited to the above-described embodiments, and can be applied to various embodiments.

For example, in the embodiment, the low refractive index region 30 is divided into the plurality of low refractive index regions 31a, 31b, 31c, and 31d, which are separated from each other. However, the plurality of low refractive index regions 31a, 31b, 31c, and 31d may be partially in contact with each other.

What is claimed is:

1. An optical waveguide component comprising:
a base material portion; and
a modified region extending in a first direction inside the base material portion and having a refractive index different from a refractive index of the base material portion,
wherein the modified region includes
a high refractive index region having a refractive index higher than the refractive index of the base material portion, and
a low refractive index region having a refractive index lower than the refractive index of the base material portion, and
wherein the low refractive index region is arranged at each of four sides of the high refractive index region in a cross-section intersecting the first direction.

2. The optical waveguide component according to claim 1,
wherein the high refractive index region includes a pair of end portions,
wherein the base material portion includes
a first end surface at which a first end portion that is one of the pair of end portions is exposed,
a second end surface at which a second end portion that is another one of the pair of end portions is exposed, the second end surface being located opposite to the first end surface in the first direction,
a first main surface connecting the first end surface and the second end surface to each other, and
a second main surface connecting the first end surface and the second end surface to each other, the second main surface being located opposite to the first main surface in a second direction intersecting the first direction,
wherein the low refractive index region includes a first low refractive index region and a second low refractive index region separated from each other in a third direction intersecting each of the first direction and the second direction,
wherein the high refractive index region is arranged between the first low refractive index region and the second low refractive index region, and
wherein a portion of the base material portion is arranged between the first low refractive index region and the high refractive index region.

3. The optical waveguide component according to claim 2,
wherein a shortest distance between the high refractive index region and the first low refractive index region is larger than a half a width of the first low refractive index region in the third direction.

4. The optical waveguide component according to claim 2,
wherein a shortest distance between the high refractive index region and the first low refractive index region is smaller than twice a width of the first low refractive index region in the second direction.

5. The optical waveguide component according to claim 2,
wherein a width of the first low refractive index region is larger than a width of the high refractive index region in the second direction.

6. The optical waveguide component according to claim 3,
wherein a width of the first low refractive index region is larger than a width of the high refractive index region in the second direction.

7. The optical waveguide component according to claim 4,
wherein a width of the first low refractive index region is larger than a width of the high refractive index region in the second direction.

8. A method of manufacturing an optical waveguide component, the method comprising:
forming, by scanning a base material portion with a laser beam along a first direction from a side of a first main surface of the base material portion, a modified region that extends in the first direction inside the base material portion and has a refractive index different from a refractive index of the base material portion,
wherein the base material portion has:
a first end surface;
a second end surface opposite the first end surface in the first direction;
the first main surface connecting the first end surface and the second end surface to each other; and
a second main surface connecting the first end surface and the second end surface to each other and located opposite the first main surface in a second direction intersecting the first direction,
wherein the modified region includes:
a high refractive index region having a refractive index higher than the refractive index of the base material portion; and
a low refractive index region having a refractive index lower than the refractive index of the base material portion, and
wherein, in the forming of the modified region, the low refractive index region is formed at each of four sides of the high refractive index region in a cross-section intersecting the first direction.
